(19) United States
(12) Patent Application Publication
(10) Pub. No.: US 2012/0246226 A1
(43) Pub. Date: Sep. 27, 2012

(54) SYSTEM AND METHOD FOR SHARING DATA FROM A LOCAL NETWORK TO A REMOTE DEVICE

(75) Inventors: Parvez Anandam, Seattle, WA (US); Chris Hopen, Shoreline, WA (US)

(73) Assignee: TAPPIN INC., Seattle, WA (US)

(21) Appl. No.: 13/427,769

(22) Filed: Mar. 22, 2012

Related U.S. Application Data
(60) Provisional application No. 61/466,850, filed on Mar. 23, 2011.

(51) Int. Cl. G06F 15/16

(52) U.S. Cl. 709/203

(57) ABSTRACT

A system and method of sharing files from a private network to a remote device. A persistent connection to a communication server is created by a client agent installed on a file sharing source device at the private network. Remote file sharing client devices connect to the communication server to access files from the file sharing source device via the communication server. A media services connector allows direct uploads of files from the file sharing source device to media service providers. A transcoder may be provided on the file sharing source device to reduce the need for transmitting large files over the network.

### CROSS REFERENCE TO RELATED APPLICATIONS

This application claims priority from U.S. Provisional Patent Application No. 61/466,850, filed on Mar. 23, 2011, entitled “SYSTEMS AND METHODS FOR SHARING DATA FROM A LOCAL NETWORK TO A REMOTE DEVICE”, which is incorporated herein by reference.

### BACKGROUND

1. Field of the Disclosure

The present disclosure relates to network data sharing and, specifically, to file sharing from a local network.

2. Description of the Related Art

Consumers have a desire to access personal files and data that would traditionally be stored on a single personal computer or other device in the home from multiple different locations and from multiple different devices. Consumers also have a desire to share personal files and data with friends and business associates, either simply for viewing (read only) or for modifying (read-write).

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of selected elements of an embodiment of a file sharing system;

FIG. 2 is a block diagram of selected elements of an embodiment of a file sharing system;

FIG. 3 is a diagram of selected elements of an embodiment of a file sharing process;

FIG. 4 is a diagram of selected elements of an embodiment of a file sharing process;

FIG. 5 is a flow diagram of selected elements of an embodiment of a file sharing process; and

FIG. 6 is a block diagram of selected elements of an embodiment of a computing device.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12. All trademarks used herein are the property of their respective owners.

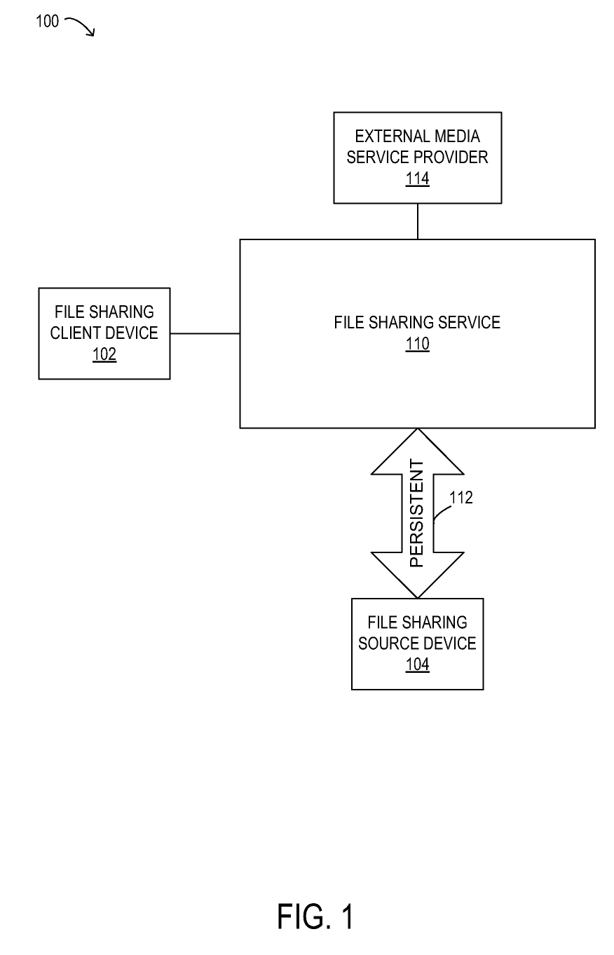

Referring now to the drawings, FIG. 1 illustrates a block diagram of selected elements of an embodiment of a file sharing system 100. FIG. 1 is shown depicting file sharing service 110 as well as certain external elements and/or services that may be provided by third parties, such as external media service provider(s) 114, for example.

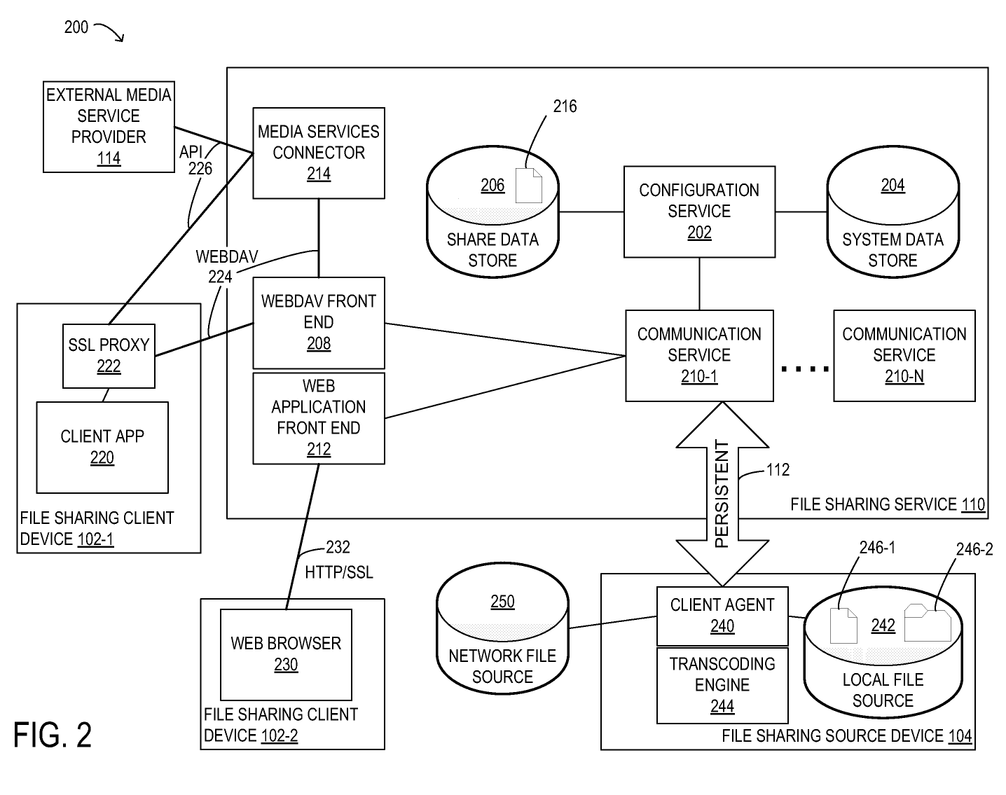

In FIG. 1, file sharing system 100 is shown including file sharing service 110, which may represent centralized computer processing resources that provide server-side functionality for a consumer-scale client-server file sharing operation (see also FIG. 2). File sharing service 110 may be accessible via public networks (such as the Internet) and/or private networks. File sharing service 110 may also be accessible via wireless communication networks. File sharing service 110 may connect via persistent connection 112 to file sharing source device 104, which may be a computer system operated by a user of file sharing service 110 and which may store certain shared file data (not shown in FIG. 1, see FIG. 2, element 246). Persistent connection 112 may be maintained by file sharing service 110 to provide uninterrupted access to file sharing source device 104 and to maintain an operational status of file sharing source device 104. In certain embodiments described in further detail, file sharing service 110 may install a client agent on file sharing source device 104 to enable file sharing services, as described herein.

Also shown in FIG. 1 is file sharing client device 102, which may be any one of a number of different types of computing devices, including a computer system, a tablet computer, a wireless telephone, other types of media players, and/or various combinations thereof. File sharing client device 102 represents a user interface for accessing file sharing functionality provided by file sharing service 110. A user of file sharing client device 102 may be able to access shared file data stored exclusively at file sharing source device 104, without any substantial constraints on a location of file sharing client device 102. Furthermore, file sharing service 110 may provide access to user media service accounts provided by external media service provider 114 (such as Facebook® or other online media services), as described in further detail herein. In this manner, users of file sharing service 110 may be enabled to transfer shared file data from file sharing source device 104 to external media service provider 114 from file sharing client device 102.

The functionality provided by file sharing service 110 may include purchase and/or activation of a file sharing service account and subsequent establishment of persistent connection 112. A user of file sharing system 100 may be enabled to set up and configure local and/or network file sources at file sharing source device 104. The user may designate access and security settings for specific shared file data, including which file sharing client devices 102 can access specific items of shared file data. A user of file sharing client device 102 may use a file sharing services account to authenticate themselves and gain access to a particular instance of file sharing source device 104. Alternatively, file sharing service 110 may provide for a desired level of access to shared file data from a plurality of file sharing source devices 104, for example, when users allow public access to shared file data.

Furthermore, the particular architecture of file sharing system 100 may enable an operator of file sharing service 110 to gain significant competitive advantages in offering public file sharing services. For example, since file sharing service 110 may not copy actual contents of shared file data, and may not perform computational operations on actual shared file data, file sharing service 110 may be uniquely suited for scalability with very low service costs. In one illustrative example, when transferring a large number of requested image files, file sharing source device 104 may be configured to locally generate a series of thumbnail images prior to transferring, which may reduce both bandwidth and processing that is performed centrally by file sharing service 110. The efficiency with which file sharing service 110 may be able to provide file sharing services is due to the relatively small amount of computer resources involved for file sharing operations, and because file sharing source device 104, which performs many storage and processing operations on the shared filed data, is typically owned and operated by a user of file sharing service 110.

Another unique and novel aspect of file sharing system 100 is an ability to uniquely identify each instance of file sharing source device 104 and respective shared file data in a manner that allows for secure and efficient organization of vast amounts of public or private file storage. In other words, file sharing system 100 may efficiently and securely maintain a catalogue of private data file sources for any number of public users using file sharing service 110, including all the users of the Internet.

Turning now to FIG. 2, a block diagram of selected elements of an embodiment of a file sharing system 200 is shown. File sharing system 200 may represent one example embodiment of file sharing system 100 (see FIG. 1). FIG. 2 is shown depicting elements included with file sharing service 110 as well as certain external elements and/or services that may be provided by third parties, such as external media service provider(s) 114, for example.

System Overview

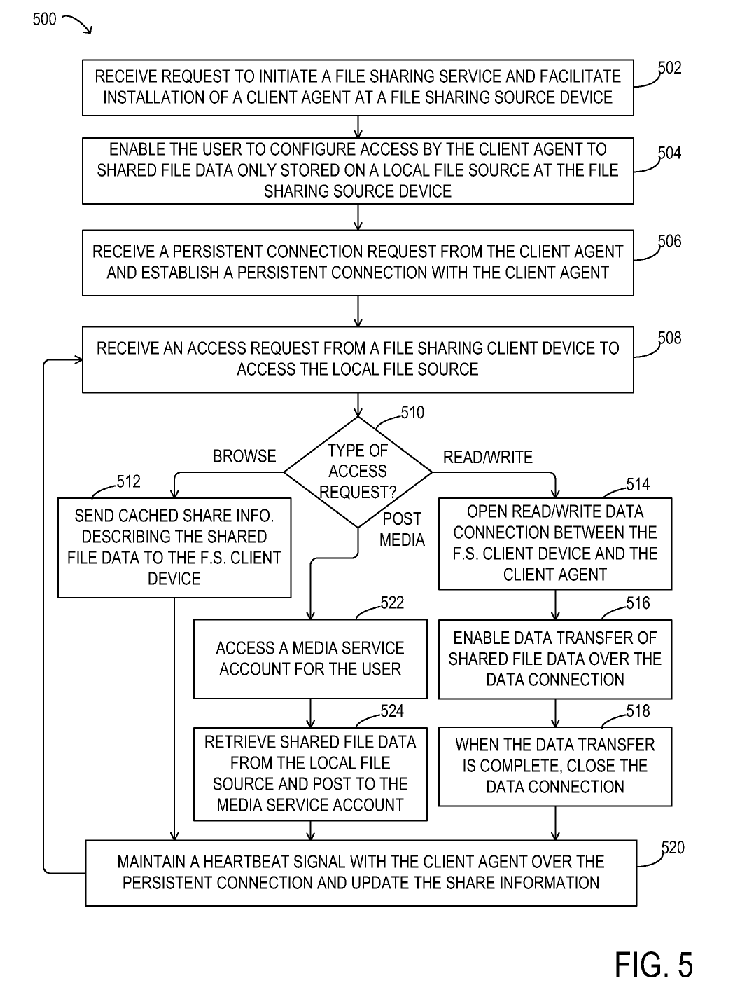

File sharing system 200 may enable providing access to shared file data 246 stored on local file source 242 at file sharing source device 104 to file sharing client device 102. Shared file data 246 may include shared data file 246-1 and shared directory 246-2, among other types of file-related data objects (not shown). In one embodiment, file sharing source device 104 is a personal computer (see also FIG. 5) with an Internet connection, for example, at a residential location associated with a user of file sharing system 200. File sharing client device 102-1 may be a smart phone or a similar device with defined networking and display capabilities. File sharing client device 102-2 may be a personal computer attached to a remote network and running a standard web browser.

File sharing source device 104 may provide access to files or other types of data, represented by shared file data 246, from local file source 242 and/or network file source 250, which may be remotely located or may be distributed over various locations. Local file source 242 may represent non-transitory computer-readable media attached to file sharing source device 104, such as a hard disk drive, a removable flash drive, or an optical disk drive, among others. Network file source 250 may be accessible to file sharing source device 104 via a network, such as a shared volume accessible from another computing device attached to a home network (not shown in FIG. 2), or another type of network storage arrangement.

To access the file sharing service 110, file sharing source device 104 includes client agent 240. Client agent 240 may be downloaded software that runs on file sharing source device 104 and may retrieve content when asked to do so by communication service 210 to which it is connected via persistent connection 112, as described in further detail below. File sharing source device 104 may also include transcoding engine 244, which may be downloaded along with client agent 240.

File sharing service 110 may further include one or more instances of communication service 210, illustrated as communication service 210-1 through communication service 210-N. Communication service 210 may facilitate communication between file sharing client device 102 and client agent 240. Communication service 210 may mediate traffic and may enforce security policies specified by a file sharing services account to which the user has subscribed. Communication service 210 may also record information about connected client agent 240 in a database, such as system data store 204.

File sharing service 110 may also include configuration service 202, illustrated in FIG. 2 as communicating with communication service 210-1, in an exemplary embodiment. In various embodiments (not shown), file sharing service 110 may include a configuration service for each respective communication service. A single instance of configuration service 202 is illustrated herein for descriptive clarity. Configuration service 202 may communicate with share data store 206 and/or system data store 204. Configuration service 202 may manage configuration share information 216, which may include meta-information about shared volumes made available by client agent 240 connecting to file sharing service 110. In certain embodiments, configuration service 202 stores share information 216 in share data store 206. In various embodiments, configuration service 202 sends information to file sharing client device 102 about shared file data 246 that is currently online and accessible with respect to a given file sharing service account. Configuration service 202 may also send information to file sharing client device 102 about other types of shared information that is available through file sharing service 110.

System data store 204 may represent a repository of long-term settings associated with file sharing service 110. System data store 204 may maintain data relating to a session state, such as a state of a particular instance (or session) of persistent connection 112 or a data connection. Although shown in FIG. 2 being accessed by configuration service 202, system data store 204 may provide useful information for and/or be accessed by a number of different elements in file sharing system 200.

In one embodiment, remote access to file sharing service 110 from file sharing client device 102 may be accomplished in a variety of ways. For example, file sharing client device 102-2 may connect via web browser 230 via hypertext transfer protocol/secure sockets layer (HTTP/SSL) link 232 to web application front end 212 of file sharing service 110. Web application front end 212 may present shared content to requesting web browsers, such as web browser 230. Web application front end 212 may also allow users of file sharing service 110 to configure file sharing account settings, such as identifiers of shared file data 246 and settings related thereto, such as access settings. Web application front end 212 may also be used by file sharing client device 102 to browse content made available by file sharing source device 104.

To connect to file sharing service 110 from file sharing client device 102-1, which may represent a mobile communication device, client app 220 may be installed and executed on file sharing client device 102-1. Client app 220 may be specifically implemented for an operating system (not shown) executing on file sharing client device 102-1, such as iOS® and Android®, among others. When file sharing client device 102-1 may not natively support SSL communication, SSL proxy 222 may be installed on file sharing client device 102-1. Client app 220 may then communicate over SSL using Web Distributed Authoring and Versioning (WebDAV) link 224 to WebDAV front end 208, and access file sharing functionality via WebDAV queries. File sharing client device 102 may also connect to WebDAV front end 208 using a standard WebDAV client (not shown) instead of client app 220, which may be tailored for use with file sharing service 110.

Client app 220 may allow access to shared content, such as shared file data 246, on a mobile device. In one embodiment, client app 220 communicates with configuration service 202 to obtain share information 216 that is available to a given user of file sharing client device 102-1. Share information 216 may be updated by configuration service 202 based on which client agents 240 are currently connected via communication service 210. In one embodiment, client app 220 may communicate with a particular instance of communication service 210 to obtain shared file data 246 from a given instance of client agent 240.

WebDAV front end 208 may be implemented as a thin proxy layer that reduces the negotiation of redirects by file sharing client device 102 to different instances of communication service 210 for load balancing and/or for other reasons. One limitation of existing standard WebDAV clients may be an inability to navigate to a different server once communication with a first server is established when a shared volume is mounted. Accordingly, WebDAV front end 208 may serve as a standard network reference for WebDAV clients to connect to while allowing file sharing service 110 to scale to multiple instances of communication service 210, such that WebDAV queries (not shown) are transmitted to an appropriate instance of communication service 210 for processing.

As shown in FIG. 2, file sharing system 200 includes media services connector 214. Client app 220 may interact with media services connector 214 via application programming interface (API) 226. Media services connector 214 may receive a request from client app 220 to post a particular picture, video, or other file from local file source 242 and/or network file source 250 to a media service account (not shown) provided by external media service provider 114 (such as Facebook® or other online media services). Media services connector 214 may fulfill the request by retrieving an appropriate version of the picture, video, or other file from file sharing source device 104 via WebDAV front end 208 and via communication service 210. Media services connector 214 may then post the retrieved data to external media service provider 114 via API 226, which may be specified by external media service provider 114. In one embodiment, media services connector 214 may communicate directly with communication service 210 instead of going through the WebDAV front end 208. In particular embodiments, media services connector 214 may be configured to retrieve information from external media service provider 114 for display in response to a request from file sharing client device 102.

In FIG. 2, transcoding engine 244 of file sharing source device 104 may be configured to transcode files from local file source 242 and/or network file source 250 that are requested by communication service 210. For example, a large image file may be stored in file storage. The large image may be of a size higher than could be effectively displayed by file sharing client device 102-1 and/or too large for reasonable transmission to file sharing client device 102-1. Transcoding engine 244 may retrieve the large image file from local file source 242 in response to a request received by client agent 240 and may convert the large image file to a smaller image file (either in size or resolution) for transmission to communication service 210 by client agent 240. In one example embodiment, transcoding engine 244 may generate a series of thumbnail images from image files stored at local file source 242. Thus, transcoding engine 244 may serve to reduce an amount of data transferred over persistent connection 112 and subsequent network connections, as compared to a system in which communication service 210 (or another network service) performs the transcoding. Additionally, computing resources consumed by transcoding engine 244 are provided by file sharing source device 104, which may provide an important competitive advantage in reducing costs associated with operation and maintenance of file sharing service 110.

Transcoding engine 244 may determine an appropriate size (or resolution) for the requested file based on characteristics of a requesting device, or may provide a transcoded file based on parameters passed in a WebDAV query. The WebDAV query processed by file sharing service 110 may be extended via query string parameters to provide this extra information to transcoding engine 244. The extensions available in the WebDAV query may include options for retrieving a group of thumbnails of files available in a directory, for retrieving a list of files available in a given directory, and other such options. When the queries are transmitted in WebDAV format, the responses produced by client agent 240 and transmitted to the requesting device by communication service 210 may not be limited to WebDAV extensible markup language (XML) response format. For example, the response may be a Media RSS (MRSS) feed representing the files available in a directory.

Communication Between Client Agent and Communication Service

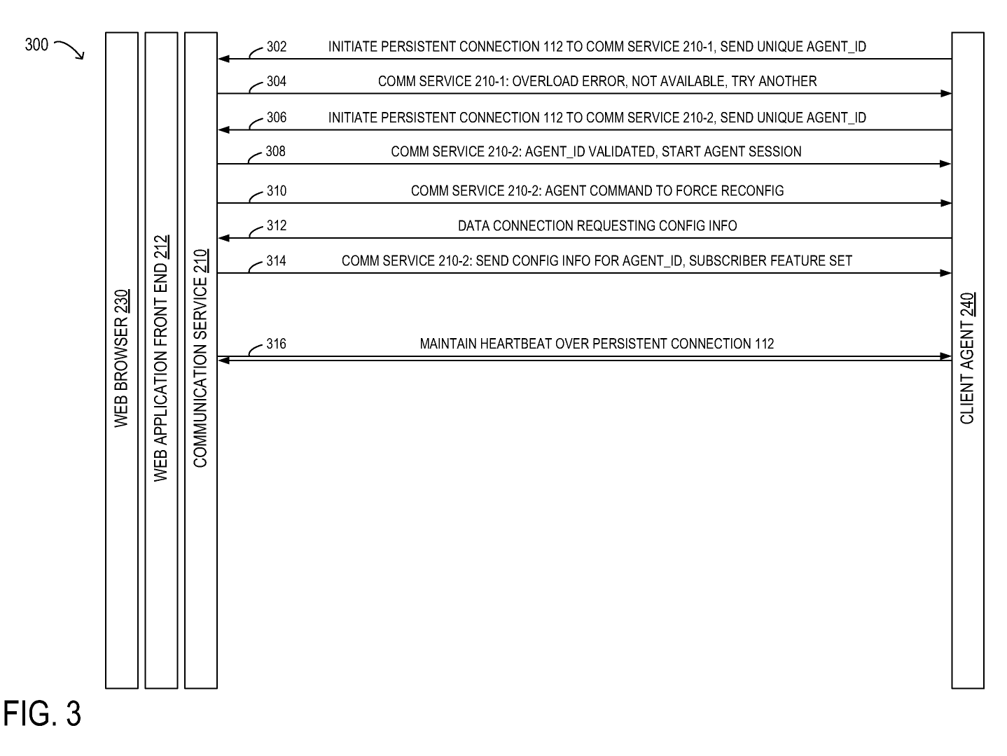

Client agent 240 may maintain persistent connection 112, which may be a persistent Transmission Control Protocol/Internet Protocol (TCP/IP) connection, to communication service 210. When client agent 240 first starts up, client agent 240 and communication service 210 may perform an initial handshake where client agent 240 authenticates with communication service 210 and communication service 210 passes configuration information to client agent 240 (see also FIG. 3). From then on, persistent connection 122 may be used to pass messages between communication service 210 and client agent 240. Once the initial handshake is finished, persistent connection 112 may be used by client agent 240 to receive messages via communication service 210. In given embodiments, once persistent connection 112 is established, subsequent requests or commands may be initiated by communication service 210 on behalf of file sharing service 110.

In a particular embodiment, the initial handshake is initiated by client agent 240. In other words, persistent connection 112 may be initiated by client agent 240 opening an outbound connection from file sharing source device 104 to file sharing service 110, and more specifically, to communication service 210. Such an arrangement may be beneficial in situations where communication service 210 is unable to directly connect to client agent 240, such as when client agent 240 is installed on a home network, behind a firewall or a network-address translation device (e.g., a router or a bridge) that might block such inbound communication, but would allow such outbound communication. One purpose of the initial handshake is to authenticate client agent 240 so communication service 210 is assured that persistent connection 112 is properly made with a device associated with a valid file sharing services account for file sharing service 110 and to make client agent 240 aware of the configuration information, which may be specific to the file sharing services account, that is maintained on file sharing service 110. Some examples of configuration information passed by the communication service to client agent 240 include, but are not limited to: (1) a universal resource locator (URL) to use for data channel requests; (2) a URL to use for downloading client agent updates; and (3) a URL to use for uploading logs.

Persistent connection 112 may also include a “control channel” (not shown), that is suitable for short messages (e.g., commands) that flow through persistent connection 112 instructing client agent 240 and/or communication service 210 to perform certain specified actions. Persistent connection 112 may be used to establish a “data channel” (not shown), that is suitable for the transfer of file contents. Commands received over the control channel may be intended to result in a corresponding action by the receiving party and may be processed in a sequential and/or serial manner. Therefore, the control channel may be used for relatively compact data transfers, such as text commands, parameters, short instructions, etc., to obtain a desirable low latency over the control channel. In contrast, the data channel may be used to transfer shared data file contents that may involve large data volumes and may involve streaming operations that extend over longer periods of time. In some embodiments, client agent 240 may open more than one instance of persistent connection 112 to communication service 210. For example, multiple instances of the control channel and/or the data channel may be simultaneously maintained over persistent connection 112. The number of instances of open channels may be adjusted to achieve desired operational characteristics. For example, a relatively small number of control channels may be maintained with respect to a number of open data channels. In certain embodiments, bandwidth and/or capacity constraints may be applied to channels carried by persistent connection 112. In one particular example, a request for a series of thumbnail images may be received at client agent 240 on a control channel, while client agent 240 may respond by sending the requested thumbnail images on a data channel.

Once the initial handshake is performed, heartbeat messages (not shown) may be sent by communication service 210 to client agent 240 at regular intervals, for example, once per minute. The heartbeat messages allow communication service 210 to ascertain with a high degree of certainty that client agent 240 is online and capable of handling requests. When a specified threshold number of heartbeat messages in a row are not acknowledged by client agent 240, the currently active session with client agent 240 and persistent connection 112 may be terminated by communication service 210 and communication service 210 may record, for example, in system data store 204, that client agent 240 is presently inactive. In certain embodiments, the heartbeat messages may be used to determine and update current values for an effective achievable data transfer rate and/or latency of data transfer over persistent connection 112. A heartbeat messages may provide communication service 210 with certain information about client agent 240, for example, a current operational status of client agent 240. The heartbeat message may also provide communication service 210 with updates that reflect changes to local file source 242, which may be used to update share information 216.

In certain instances, client agent 240 may use the control channel to respond with shared file data 246, for example, when the requested amount of data is relatively small. However, when client agent 240 receives a message on the control channel that involves a larger data transfer, client agent 240 may perform the requested action and then reply on a new data channel connection that is initiated by client agent 240 for this purpose. In this case, client agent 240 may elect to not use the existing control channel to respond, since a slow response might block incoming messages, depending on a particular operational scenario. A new data channel connection may remain open as is appropriate to respond to received messages and/or commands. In one embodiment, an HTTPS request to open a data channel is specified as a so-called “Keep-Alive” request that remains open after a data transfer operation on the data channel is completed, such that the data channel can efficiently be reused for multiple transfer operations. Since having to perform an SSL handshake for every data channel request may significantly increase latency when larger numbers of requests arrive in bursts, such as when requests for whole sets of images in a directory are received, maintaining an open data channel connection can improve overall performance of file sharing service 110.

The novel use of persistent connection 112 with file sharing service 110 is beneficial for a number of reasons. From the point of view of a requesting user operating file sharing source device 104, file sharing service 110 is desirably available to service user requests with a high degree of reliability, even though various aspects of operation of file sharing source device 104 may vary, for example, a network connection, power state, user account, login state, etc. Having persistent connection 112 allows file sharing service 110 to know when file sharing source device 104 is and is not available, which allows file sharing service 110 to reliably provide such availability information to file sharing client device 102 requesting file sharing services. Thus, a user of file sharing client device 102 may be kept updated about the status of file sharing services available in near real-time. From a point of view of a user of file sharing client device 102 requesting access to shared file data 246, shared filed data 246 may effectively appear to originate from file sharing service 110, even though shared file data 246 may be present as a singular copy stored at file sharing source device 104.

Initial Handshake Protocol

Referring now to FIG. 3, a diagram of selected elements of an embodiment of file sharing process 300 is illustrated. File sharing process 300 may be implemented using file sharing service 110 (see FIGS. 1 and 2). File sharing process 300 is depicted in FIG. 3 in protocol format where time advances from top to bottom. In FIG. 3, various layers of file sharing service 110, as described previously herein, are depicted, including web browser 230, web application front end 212, communication service 210, and client agent 240. As shown, file sharing process 300 depicts an initial handshake between communication service 210-1, communication service 210-2, and client agent 240, as mentioned previously for starting up file sharing service 110. It is noted that file sharing process 300 is described with an exemplary reference to file sharing client device 102-2 executing web browser 230 for descriptive clarity. It will be understood that in other embodiments (not shown), file sharing process 300 may be implemented with file sharing client device 102-1 executing client app 220. It is noted that operations in file sharing process 300 may be omitted, augmented, and/or rearranged in different embodiments.

File sharing process 300 may begin by client agent 240 sending (operation 302) a request to communication service 210-1 to initiate persistent connection 112 (see FIGS. 1 and 2) and send a unique agent_ID that identifies client agent 240. In one embodiment, communication service 210-1 may send (operation 304) a response indicating an overload error and not being available to handle operation 302 at a current time, along with an instruction to try another instance of communication service 210. Client agent 240 may then send (operation 306) a request to communications service 210-2 to initiate persistent connection 112 and send the unique agent_ID. Communication service 210-2 may accept the request in operation 306 and may send (operation 308) a response confirming that the agent_ID has been validated and a notification that an agent session has been started. Communication service 210-2 may also send (operation 310) a command to force reconfigure client agent 240. Client agent 240 may then send (operation 312) a response opening a data connection and requesting configuration information for the agent session and agent_ID. Communication service 210-2 may subsequently send (operation 314) a response including the configuration information corresponding to the agent_ID, which may be linked to a particular file sharing service account, along with a subscriber feature set that may correspond to purchased account services. After operations 302-314 have been completed, a heartbeat may be maintained (operation 316) over persistent connection 112.

End-to-End Data Flow

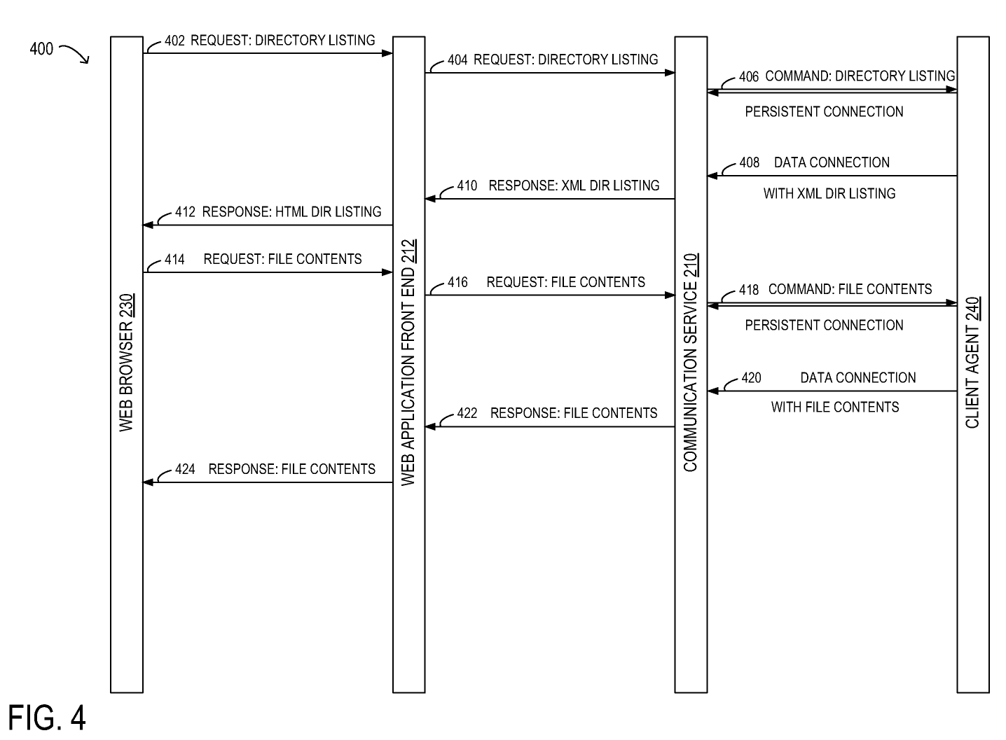

Referring now to FIG. 4, a diagram of selected elements of an embodiment of file sharing process 400 is illustrated. File sharing process 400 may be implemented using file sharing service 110 (see FIGS. 1 and 2). File sharing process 400 is depicted in FIG. 4 in protocol format where time advances from top to bottom. In FIG. 4, various layers of file sharing service 110, as described previously herein, are depicted, including web browser 230, web application front end 212, communication service 210, and client agent 240. As shown, file sharing process 400 depicts transfer shared file data 246 between web browser 230 and client agent 240, as mentioned previously. It is noted that file sharing process 400 is described with an exemplary reference to file sharing client device 102-2 executing web browser 230 for descriptive clarity. It will be understood that in other embodiments (not shown), file sharing process 400 may be implemented with file sharing client device 102-1 executing client app 220. It is noted that operations in file sharing process 400 may be omitted, augmented, and/or rearranged in different embodiments.

In FIG. 4, file sharing process 400 illustrates various aspects of one embodiment of a round-trip between a client agent and a file sharing client device passing through a file sharing service, as described herein. It is assumed that the initial handshake described above with respect to FIG. 3 has already occurred, and so the message sent by communication service 210 to client agent 240 is sent on a previously existing instance of persistent connection 112 (see FIGS. 1 and 2). File sharing process 400 illustrates the use of the control channel for message passing and of the data channel for the actual contents of the requested data. In the exemplary embodiment of file sharing process 400 shown in FIG. 4, the data is sourced from client agent 240 (i.e., a read operation). However, in various embodiments, a similar flow as shown in file sharing process 400 may be used for write operations and/or other operations. In a write operation (not shown), file sharing client device 102 may send data to be written in an initial request, and that data may be sent to client agent 240 for writing to local file source 242 over a data channel.

In various embodiments, the data sent over the data channel is shared data file 246-1 (see FIG. 2), which may represent any of a number of different types of files, such as an image file or a word processing document. In certain instances, shared data file 246-1 may be transmitted in entirety before being displayed by file sharing client device 102. In other cases, shared data file 246-1 may also be transmitted in a streaming manner, so that at least certain portions of an audio file or video file could be displayed (or otherwise processed and/or output) by file sharing client device 102 before the complete file has been received.

File sharing process 400 may begin with web browser 230 sending (operation 402) a request for a directory listing to web application front end 212. Web application front end 212 may forward (operation 404) the request for the directory listing to communication service 210. Communication service 210 may send (operation 406) a command over persistent connection 112 to client agent 240 to obtain the requested directory listing. Client agent 240 may respond (operation 408) by opening a data connection to communication service 210 and sending the directory listing in XML-format. Communication service 210 may then forward (operation 410) the response including the directory listing in XML-format to web application front end 212. Web application front end 212 may then forward (operation 412) the response including the directory listing in hypertext markup language (HTML)-format to web browser 230, which may enable web browser 230 to display the directory listing. In certain embodiments, operations 402-412 represent an atomic operation of file sharing service 110.

File sharing process 400 may continue with web browser 230 sending (operation 414) a request for file contents to web application front end 212. The request in operation 414 may include additional parameters, such as an agent_ID, a file identifier, or authentication credentials, among other examples. Web application front end 212 may forward (operation 416) the request for the file contents to communication service 210. Communication service 210 may send (operation 418) a command over persistent connection 112 to client agent 240 to obtain the requested file contents. Client agent 240 may respond (operation 420) by opening a data connection to communication service 210 and sending at least a portion of the file contents. Communication service 210 may then forward (operation 422) the received file contents to web application front end 212. Web application front end 212 may then forward (operation 424) the received file contents to web browser 230. In certain embodiments, operations 414-424 represent an atomic operation of file sharing service 110.

Scalability

The services included with file sharing service 110, such as communication service 210, configuration service 202, media services connector 214, WebDAV front end 208, and web application front end 212, are designed with relatively light initialization and termination protocols for ease of operation. In one embodiment, the services are independent of each other and use system data store 204 for inter-communication, such as for configuration and for accessing long-term session information. The deployment of various services in file sharing service 110 may be automated, while each service may be independently updated.

Each instance of communication service 210 may be capable of handling a plurality of instances of client agent 240. In some case, file sharing service 110 may be suited for connecting to any number of client agents 240. In certain embodiments, a particular instance of communication service 210 may be limited by a number of persistent connections 112 made by client agents 240 that can be supported. In particular embodiments, a connection to system data store 204 is established to bring any of the services, such as web application front end 212, communication service 210, or configuration service 202, online. Each of the services described above may have different scaling curves for connection loading volume and may be started and terminated independently.

Security

File sharing system 100 and 200 (see FIGS. 1 and 2), as described herein, may employ a variety of security features. When creating a new file sharing service account with file sharing service 110, an identifier for a user, such as an email address, may be collected. File sharing service 110 may validate the email address to take precautions against attackers from posing as users, for example by checking domain name server (DNS) records to ensure that the domain is valid; and/or by sending a confirmation email with an activation link to the email address. After the user has successfully completed the validation process, the file sharing service account may be opened and the user may be afforded access to file sharing service 110. Before the validation process is completed, however, the user may be prevented from associating a client agent with the user's file sharing service account. Such precautions may protect users from various malicious acts and malicious actors seeking unauthorized access to shared file data 246.

Once the file sharing service account is activated, a next step is to install client agent 240 on file sharing source device 104. The installer of client agent 240 may be digitally signed with a code-signing certificate issued by a trusted root certification authority digitally time stamped. In one embodiment, all network communication between portions of a file sharing system as described herein, including communication between the communication service and the client agent, is over transport layer security (TLS) connections, such as an SSL connection, including streaming media connections.

Each instance of client agent 240 may be assigned a unique identifier, referred to as an “agent ID” or “agent_ID”. In one embodiment, the agent ID is a combination of a machine identifier (e.g., a Win32_ComputerSystemProduct from a Microsoft Windows PC, a Hardware UUID from SPHardwareDataType on an Apple computer, a media access control (MAC) address of a network integrated controller on a Linux computer, etc.) and a username for a local operating system user account. Thus, the agent ID may specify a user that runs processes on file sharing source device 104 associated with client agent 240. In different embodiments, a user of file sharing service 110 may be an individual user or a system user (such as “Local Service” or “root”).

When client agent 240 is first installed by a user on file sharing source device 104, the client agent 240 may use an email address and a password provided by the user to register a file sharing service account with file sharing service 110. The registration process may then bind the agent ID to the file sharing service account of the user.

Client agent 240 may authenticate user credentials with communication service 210 within a TLS connection that client agent 240 initiates. Client agent 240 may present the email address and password that the user has provided for validation, for example, as a TLS Basic Auth authorization challenge. Therefore, in particular embodiments, client agent 240 may only successfully connect to file sharing service 110 using valid credentials.

A similar authentication process may be used for client app 220 through web application front end 212, including authenticating over a TLS Basic Auth authorization challenge. The supplied email address and password may be used as the authentication credentials. Client app 220 may also include features such as inactivity timeout periods or requesting passwords upon each sign-in to protect a client endpoint in file sharing service 110 from unauthorized access.

Once authenticated, file sharing service 110 manages access to shared file data 246 shared by client agent 240. File sharing service 110 may store information concerning which shared volumes, directories, files, and so on a given authenticated user has permission to access. File sharing service 110 may then enforce the stored permission setting.

File sharing service 110 may also allow a user to share files with other users by simply providing the other user's email address. In one embodiment, shared users are sent an email invitation to access the shared content securely.

Turning now to FIG. 5, a flow diagram of selected elements of an embodiment of a file sharing process 500 is shown. File sharing process 500 may be implemented using file sharing system 100 and 200 (see FIGS. 1 and 2). Elements in file sharing process 500 may be omitted, augmented, or rearranged in different embodiments.

File sharing process 500 may begin by receiving (operation 502) a request to initiate a file sharing service and facilitate installation of a client agent at a file sharing source device. The user may be enabled (operation 504) to configure access by the client agent to shared file data only stored on a local file source at the file sharing source device. A persistent connection request may be received (operation 506) from the client agent and a persistent connection may be established with the client agent. An access request may be received (operation 508) from a file sharing client device to access the local file source. Then, a decision may be made (operation 510) about what type of access request was received in operation 508. If the access request received in operation 508 was a BROWSE-type access request, file sharing process 500 may send (operation 512) cached share information describing the shared file data to the file sharing client device.

If the access request received in operation 508 was a READ/WRITE-type access request, file sharing process 500 may open (operation 514) a read/write data connection between the file sharing client device and the client agent. The data transfer of at least a portion of the shared file data may be enabled (operation 516) over the data connection. The data transfer in operation 516 may refer to a copy operation or a move operation. In one embodiment, the data transfer is a read-type copy operation in which at least a portion of the data file, of which an original version may have been stored only at the file sharing source device (i.e., without any other duplicates or copies stored by the file sharing system), is transferred to the file sharing client device. The read-type copy operation may result in a singular copy of the data file being created and/or retained only at the file sharing client device. In other words, even though many intermediary devices and network components may be involved with the data transfer, only the file sharing client device may retain a copy of the data file after the data transfer is completed. In another embodiment, the data transfer is a write-type copy operation in which at least a portion of the data file, of which an original version may have been stored only at the file sharing client device, is transferred to the file sharing source device. The write-type copy operation may result in a singular copy of the data file being created and/or retained only at the file sharing source device. When the data transfer is complete, the data connection may be closed (operation 518).

If the access request received in operation 508 was a POST MEDIA-type access request, file sharing process 500 may access (operation 522) a media service account for the user. The media service account may be provided by an external media service provider. At least a portion of the shared file data may be retrieved and posted (operation 524) to the media service account.

File sharing process 500 may proceed by maintaining (operation 520) a heartbeat signal with the client agent over the persistent connection and update the share information. File sharing process 500 may then loop back to operation 508 or wait for operation 508. In certain embodiments, operation 520 may be performed in parallel or concurrently with other operations in file sharing process 500.

In various embodiments, a server, front end, engine, provider, application, service, and the like, may include a physical computing device, such as a personal computer, a server computer, and the like, specifically programmed via computer-executable instructions stored on a tangible computer-readable storage medium to provide the described functionality.

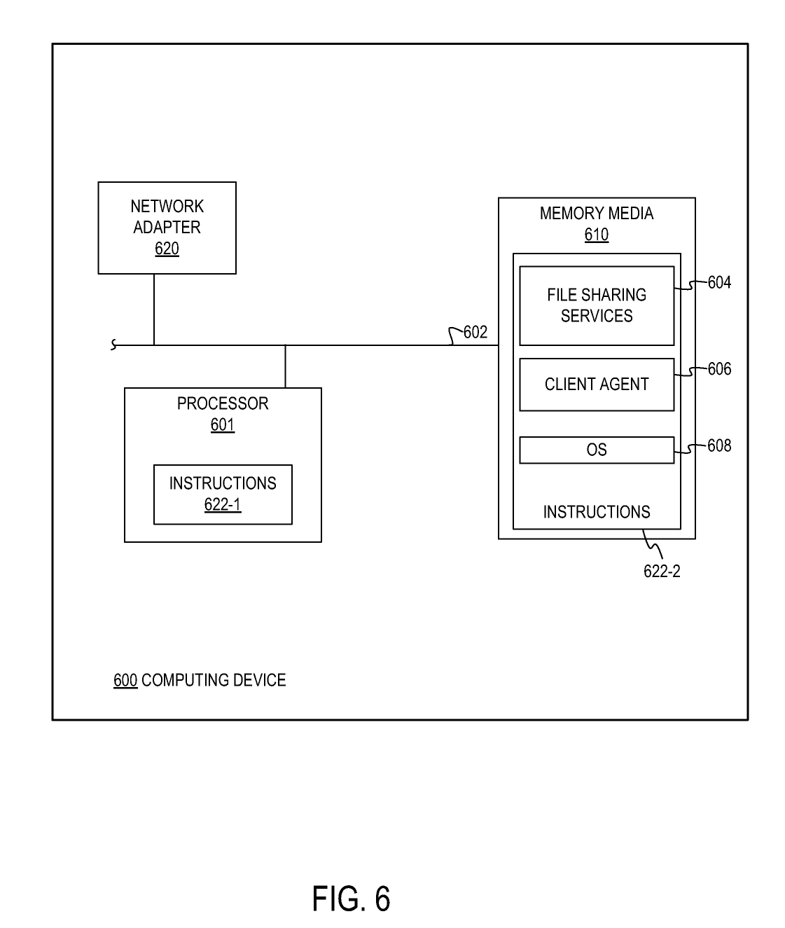

Referring now to FIG. 6, a block diagram illustrating selected elements of an embodiment of a computing device 600 for performing file sharing services is presented. In the embodiment depicted in FIG. 6, device 600 includes processor 601 coupled via shared bus 602 to processor accessible storage media collectively identified as memory media 610. It is noted that shared bus 602 may be configured to provide access to additional storage devices or memory media (not shown in FIG. 6), for example, using network adapter 620, a peripheral adapter (not shown) and/or another means (not shown in FIG. 6).

Device 600, as depicted in FIG. 6, further includes network adapter 620 that interfaces device 600 to a network (not shown in FIG. 6). Memory media 610 encompasses persistent and volatile media, fixed and removable media, and magnetic and semiconductor media. Memory media 610 is operable to store instructions, data, or both. Memory media 610 is shown storing instructions 622-2, which may represent one or more sets of instructions and data structures embodying or utilized by any one or more of the methods, processes, services, and/or operations described herein. It is noted that instructions 622-1 may also reside, completely or at least partially, within processor 601 during execution thereof by computer device 600. It is further noted that processor 601 may be configured to receive instructions 622-2 from instructions 622-1 via shared bus 602. Memory media 610 as shown includes sets or sequences of instructions 622-2, namely, operating system 608, file sharing services 604, and client agent 606, as described in detail above. File sharing services 604 may represent at least some portions of file sharing services 110 (see FIGS. 1 and 2). Client agent 606 may be an embodiment of a compressed or executable version of client agent 240 (see FIG. 2).

In some embodiments, memory media 610 is configured to store and provide executable instructions for executing at least certain portions of file sharing services 604, as mentioned previously. For example, file sharing services 604 may be configured to execute at least certain portions of file sharing process 300, 400, and/or 500. In certain embodiments, computing device 600 may represent an implementation of file sharing source device 104 (see FIGS. 1 and 2) that can execute client agent 240.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for providing a file sharing service, comprising:
receiving a first request to establish a persistent connection from a client agent at a file sharing source device, wherein the client agent is configured to access a local file source at the file sharing source device on behalf of a user, and wherein the first request includes an agent identifier that is unique to the client agent;
responsive to the first request, initiating the persistent connection with the client agent, including validating the agent identifier;
receiving, from the client agent, share information for the local file source;
storing the share information;
receiving a second request from a file sharing client device to access the local file source via the client agent;
responsive to the second request, sending, to the file sharing client device, a stored version of the share information; and
wherein the share information describes shared file data that is stored at the local file source.

2. The method of claim 1, further comprising:
prior to the first request, receiving a third request from the file sharing source device to initiate the file sharing service;
creating a file sharing service account for the user, including validating an email address for the user;
enabling the file sharing source device to download and install the client agent; and
enabling the file sharing source device to configure the client agent to access the local file source.

3. The method of claim 1, wherein the file sharing source device is a computing device operated by the user.

4. The method of claim 3, wherein the file sharing source device is configured to provide access from a network file source using the client agent.

5. The method of claim 1, wherein the initiating the persistent connection includes:
sending a reconfigure command to the client agent; and
sending configuration information to the client agent according to the file sharing service account.

6. The method of claim 1, wherein the file sharing client device is enabled to use a file sharing service account for the user to access the shared file data.

7. The method of claim 1, wherein the client agent is configured to allow the file sharing client device to access the shared file data.

8. The method of claim 7, wherein the client agent is configured to specify a level of access to the shared file data.

9. The method of claim 1, further comprising:
receiving a fourth request from the file sharing client device to access a data file included in the shared file data;
responsive to the fourth request, establishing a data connection between the file sharing client device and the file sharing source device, wherein the data connection uses the persistent connection with the client agent; and
enabling at least a portion of the data file to be transferred over the data connection, wherein a copy of the data file is retained only at the file sharing client device.

10. The method of claim 9, wherein enabling at least a portion of the data file to be transferred over the data connection includes:
transcoding the data file to a format corresponding to the file sharing client device; and
sending at least a portion of the data file to the file sharing client device.

11. The method of claim 9, further comprising:
receiving a fifth request from the file sharing client device to post the data file to a media service account for the user at a media service provider;
responsive to the fifth request, accessing the media service account for the user;
retrieving at least a portion of the data file from the local file source; and
uploading at least a portion of the data file to the media service provider under the media service account.

12. The method of claim 1, wherein the persistent connection includes a heartbeat signal exchanged with the client agent at a regular interval, and wherein the share information is regularly updated based on the heartbeat signal.

13. A computer system for providing a file sharing service, comprising:
a processor configured to access memory media, the memory media including instructions executable by the processor to implement a file sharing service, including:
a communication service, including instructions executable to:
establish a persistent connection with a client agent at a file sharing source device; and
establish a data connection between a file sharing client device and the file sharing source device to transfer shared file data stored only at a local file source on the file sharing source device; and
a configuration service, including instructions executable to:
configure a file sharing service account for a user for the file sharing service;
maintain a share data store storing share information describing the shared file data; and
maintain a system data store storing configuration information for the file sharing source device and the file sharing service account.

14. The computer system of claim 13, wherein the file sharing service includes:
a media services connector, including instructions executable to:
access a media service account of a media service provider on behalf of the user; and
transfer shared file data to the media service account.

15. The computer system of claim 13, wherein the file sharing service includes:
a web application front end interface, including instructions executable to:
enable the file sharing client device to access the communication service using a web browser executable on the file sharing client device; and
a client application front end interface, including instructions executable to:
enable the file sharing client device to access the communication service using a client application executable on the file sharing client device.

16. The computer system of claim 13, wherein the communication service is configured to:
enable the file sharing source device to download and install the client agent; and
enable the file sharing source device to configure the client agent to access the local file source.

17. The computer system of claim 13, wherein the persistent connection includes a heartbeat signal exchanged between the communication service and the client agent at a regular interval, and wherein a client agent status is regularly updated based on the heartbeat signal.

18. A non-transitory computer readable memory medium for implementing a file sharing service, the memory medium storing instructions executable by a processor to:
receive a first request to establish a persistent connection from a client agent at a file sharing source device, wherein the client agent is configured to access a local file source at the file sharing source device on behalf of a user having a file sharing service account for the file sharing service, and wherein the first request includes an agent identifier that is unique to the client agent;
responsive to the first request, initiate the persistent connection with the client agent, including validating the agent identifier, wherein the persistent connection includes a heartbeat signal exchanged with the client agent at a regular interval;
receive, from the client agent, share information for the local file source;
store the share information;
receive a second request from a file sharing client device to access the local file source via the client agent;
responsive to the second request, send, to the file sharing client device, a stored version of the share information; and
wherein the share information describes shared file data that is stored at the local file source.

19. The memory medium of claim 18, storing instructions executable by a processor to:
prior to the first request, receive a third request from the file sharing source device to initiate the file sharing service;
create the file sharing service account for the user, including validating an email address for the user;
enable the file sharing source device to download and install the client agent; and
enable the file sharing source device to configure the client agent to access the local file source.

20. The memory medium of claim 18, wherein the file sharing client device is enabled to use the file sharing service account for the user to access the shared file data.

21. The memory medium of claim 18, wherein, based on configuration settings provided by the client agent, the file sharing client device is enabled to access the shared file data.

22. The memory medium of claim 21, wherein the configuration settings provided by the client agent specify a level of access to the shared file data.

23. The memory medium of claim 18, storing instructions executable by a processor to:
receive a fourth request from the file sharing client device to access a first data file included in the shared file data;
responsive to the fourth request, establish at least one data connection between the file sharing client device and the file sharing source device, wherein the data connection uses the persistent connection with the client agent; and
enable at least a portion of the first data file to be transferred over the data connection, wherein a copy of the first data file is created only at the file sharing client device.

24. The memory medium of claim 18, storing instructions executable by a processor to:
receive a fifth request from the file sharing client device to post a second data file to a media service account for the user at a media service provider;
responsive to the fifth request, access the media service account for the user;
retrieve at least a portion of the second data file from the local file source; and
upload at least a portion of the second data file to the media service provider under the media service account.

25. The memory medium of claim 18, storing instructions executable by a processor to:
receive a sixth request from the file sharing client device to store a third data file in the shared file data;
responsive to the sixth request, establish a data connection between the file sharing client device and the file sharing source device, wherein the data connection is established using the persistent connection with the client agent; and
enable at least a portion of the data file to be transferred over the data connection, wherein a copy of the third data file is created only at the file sharing source device.
